(19) United States
(12) Patent Application Publication
(10) Pub. No.: US 2020/0014545 A1
(43) Pub. Date: Jan. 9, 2020

(54) Method for Using Cryptography to Protect Deployable Rapid On-Site Manufacturing 3D Printing Systems and Enable a Single Time Printing Protocol

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(21) Appl. No.: 15/903,163

(22) Filed: Feb. 23, 2018

Related U.S. Application Data
(63) Continuation of application No. 14/540,003, filed on Nov. 12, 2014, now abandoned.
(60) Provisional application No. 61/903,363, filed on Nov. 12, 2013.

(51) Int. Cl. H04L 9/32

(52) U.S. Cl. CPC H04L 9/3247

(57) ABSTRACT

A method for using cryptography to protect deployable rapid on-site manufacturing 3D printing systems using a single time printing protocol. An external trusted machine provides a first key pair to the server system. The database contains encrypted copies of developer software/models, using the Trusted Machine to encrypt. The Signature Verifier verifies that devices requesting code are safe devices provided from a third party. The Trusted Machine includes a first key pair “A” used to encrypt and decrypt entries into the database safely. A trusted module is associated with the printer which comprises a random sequence generator. The printer generates keys required for printing and authorization using a Common Access Card (CAC). The server would encrypt the model with the keys generated by the trusted module of the printer to allow for the printer to decrypt the keys and effectuate printing of the encrypted model.

### CROSS REFERENCE TO RELATED APPLICATIONS

This application claims priority from and is a continuation of U.S. patent application Ser. No. 14/540,003, entitled “A Method for Using Cryptography to Protect Deployable Rapid On-Site Manufacturing 3D Printing Systems and Enable a Single Time Printing Protocol”, filed on 12 Nov. 2014.

This application claims priority from U.S. Provisional Patent Application Ser. 61/903,363, entitled “A Method for Using Cryptography to Protect Deployable Rapid On-Site Manufacturing 3D Printing Systems and Enable a Single Time Printing Protocol”, filed on 12 Nov. 2013. The benefit under 35 USC § 119e of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to rapid prototyping using 3D printers. More specifically, the present invention relates to rapid prototyping using 3D printers whereby access to the software and hardware to control the number of prints is strictly limited and protected by cryptography and printing protocols.

### BACKGROUND OF THE INVENTION

3D printing provides the ability for any user to print the products stored in a database at any location. The problem with 3D printing from a developer perspective is that of controlling the use of the models/products and the number of prints made by a user purchasing the rights to one or more prints.

What is needed is a system and method for controlling the distribution and protecting the developer's content from unauthorized manufacturing. Such a system could be one that controls the number of prints.

### SUMMARY OF THE INVENTION

The present invention teaches a system and method to create distributed software which enables access to software/hardware packages while protecting the content. This is accomplished using a scheme of encryption, verification, and trust. The application of the system and method of the present invention enables and encourages crowd sourced design by protecting the intellectual property of the developers.

A trusted module is associated with the printer, where the printer also includes a random sequence generator. The printer will generate, using its random sequence generator, the next keys required for printing and authorization using a Common Access Card (CAC). Next the server will encrypt the model with the keys generated by the trusted module of the printer to allow for the printer to decrypt the keys and effectuate printing of the encrypted model. This will limit printing of the model file sent from the Rapid Prototyping Library to the printer to only that specific printer. If the model file was copied or hijacked during transmission, it will be unable to be executed or printed by any other 3D printer as there will be no printer authentication to unlock the file for use as any other printer, even with a trusted module will be unable to decrypt the file due to the missing encryption keys.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the process on the software side of the present invention;

FIG. 2 illustrates the security features of the present invention;

FIG. 3 illustrates the asymmetric encryption;

FIG. 4 illustrates the signing and verification process;

FIG. 5 is an overview of the server system;

FIGS. 6-10 illustrate an exemplary embodiment of the present invention from the developer side;

FIGS. 11-16 illustrate an exemplary embodiment of the present invention from the device side;

FIG. 17 illustrate the single printing protocol of the present invention; and

FIG. 18 illustrated the single printing protocol of the present invention.

### DETAILED DESCRIPTION OF THE INVENTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

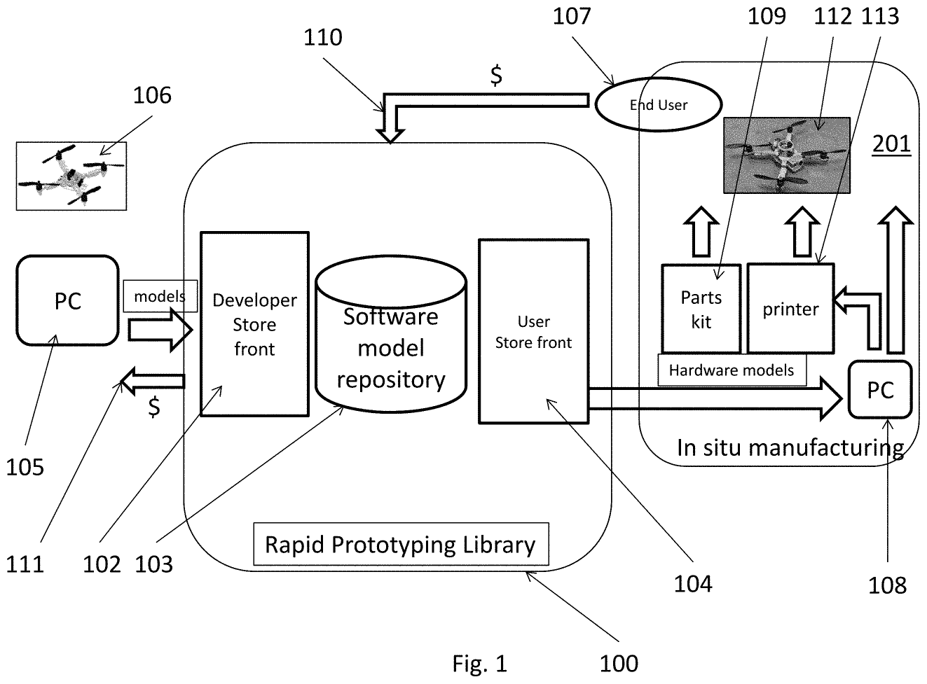

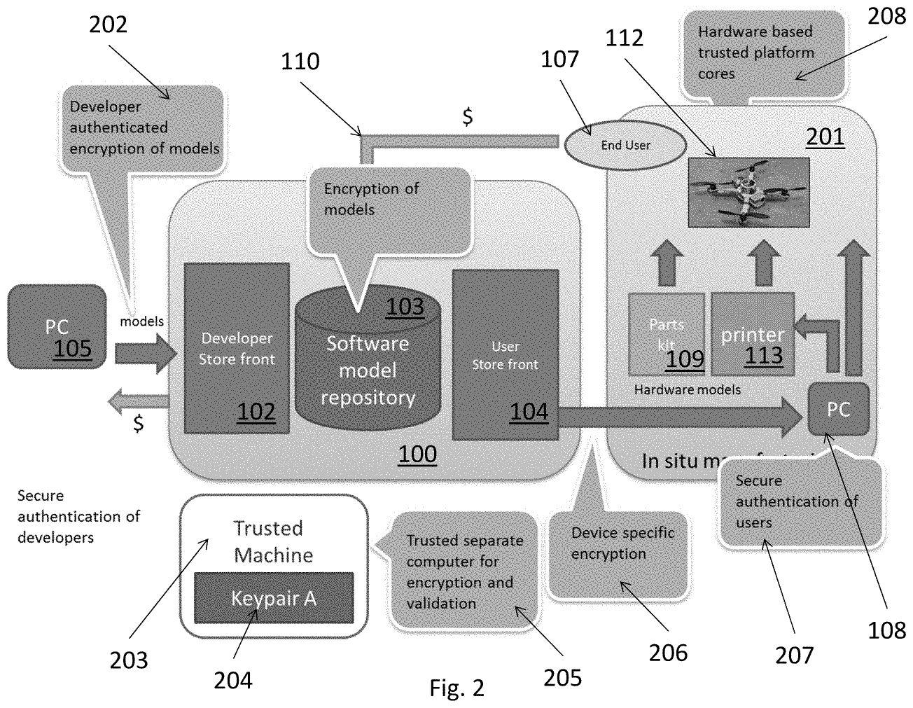

Referring to FIG. 1, a rapid prototyping library 100 is comprised of a developer store front 102, software model repository 103, and user store front 104. The developer store front 102 interacts with an external computer 105 to send and receive models 106, which are stored in the software model repository 103 and presented to end users 107 via the user store front 104.

Developers interact directly with the developer store front 102 to receive payment 111 based on the number of prints 112 made by an end user's printer 113 from each of their models purchased by an end user 107.

An end user 107 visits the user store front 104 and accesses it using a computer 108 to select their desired models 106. The end user then provides computer and 3D printer hardware at their own location from the production of the purchases models.

Optionally, the end user may also be provided a parts kit 109 for use with or in combination with printed models. Payment 110 is sent by the end user 107 to the rapid prototyping library 100 for processing to the developer 111.

The system is vulnerable to attack in several different ways. First, unauthorized access could occur to the models/software inside the rapid prototyping library 100. Second, one could impersonate a developer to gain access to the rapid prototyping library 100. Third, unauthorized requests could be made to the rapid prototyping library 100 from the end user side of the system 201. Fourth, a printed device 112 could be captured or stolen. Fifth, software from the rapid prototyping library 100 could be captured during transmission and used on an unauthorized device. Sixth, payment 110 could be withheld or not completed after the transaction. Seventh, unauthorized access to a container in the battlefield could be compromised or fall in to enemy hands, where access to the printing hardware and software is uncontrolled as is access to the rapid prototyping library 100 from previously authenticated equipment.

The present invention teaches several ways that the anticipated security breaches can be resolved. This method can also be applied in a commercial or residential setting, but is exemplified in the battlefield for purposed of illustration and explanation.

First, developers will be secured using standard authentication protocols 202. All models will be authenticated and encrypted before being stored in the rapid prototyping library 100. The present invention thus teaches where authentication of the ownership of the 3D models offered for printing through the store are subject to verification and are verified before being offered through for sale through the store from the library.

A separate, external trusted machine 203 will issue a first key pair 204 for verification between the rapid prototyping library 100 and the end user hardware 201. This trusted, separate machine 203 provides the computing power for encryption and validation services to the system 205. Upon transmission from the rapid prototyping library 100 to an end user computer 108, device specific encryption 206 is transmitted so that only the receiving device 108 can execute the software and model being transmitted. The end user's computer 108 provides secure authentication of users 207 to ensure that the user of the machine is authorized. The printed components and devices 112 are provided with hardware based trusted platform cores 208 so that parts can only be recognized and controlled in specific combinations.

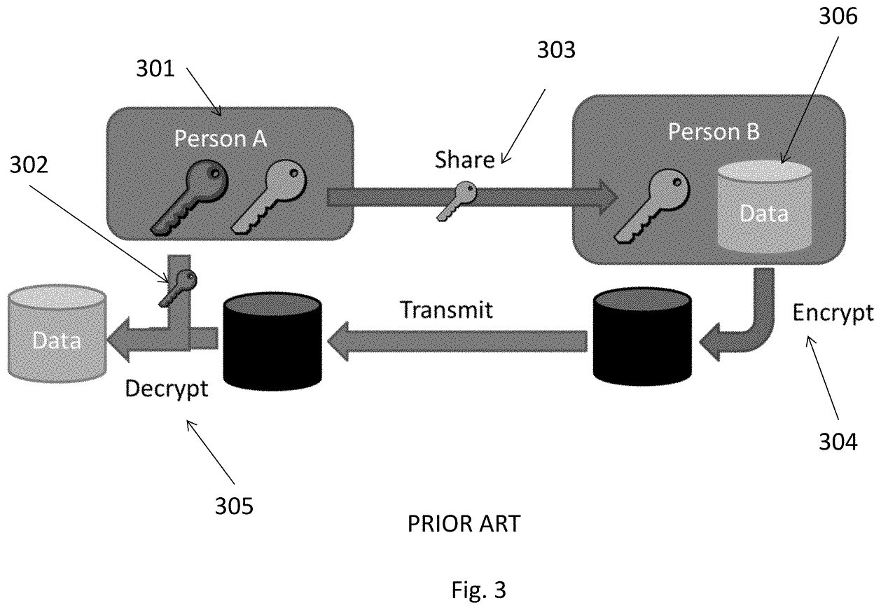

As shown in FIG. 3, asymmetric encryption, also known as public-key encryption will be used to protect the data. A special key pair 301 is created, one public and one private. The private key 302 is kept safe by the person decrypting the data 306, while the public key 303 is sent out to an end user. Anybody can encrypt 304 data with this public key 303 but it can only be decrypted 305 by the person with the private key 302.

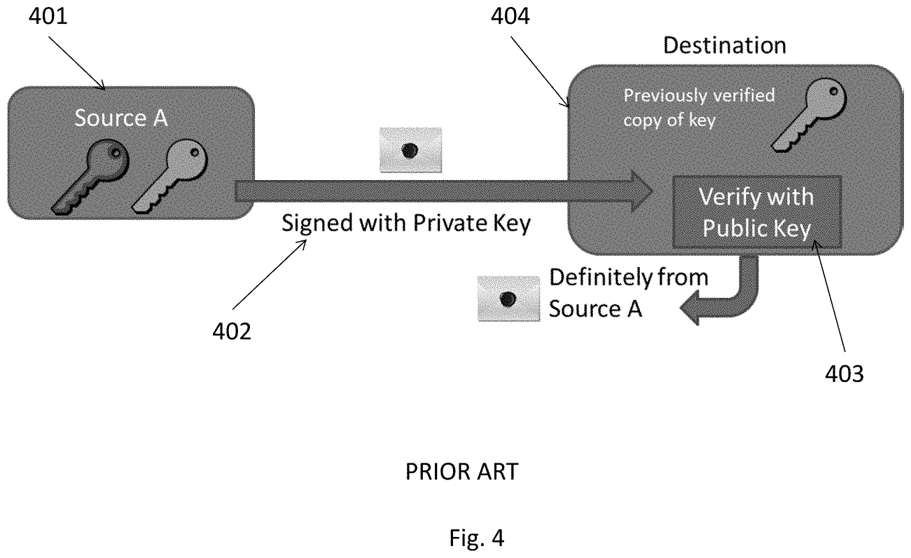

Signing uses different algorithms than encryption but similar keys. A source 401 can sign data with a private key 402 and the signature can be verified with the public key 403. If the destination 404 trusts the public key, then they can trust that the corresponding signature is valid as shown in FIG. 4.

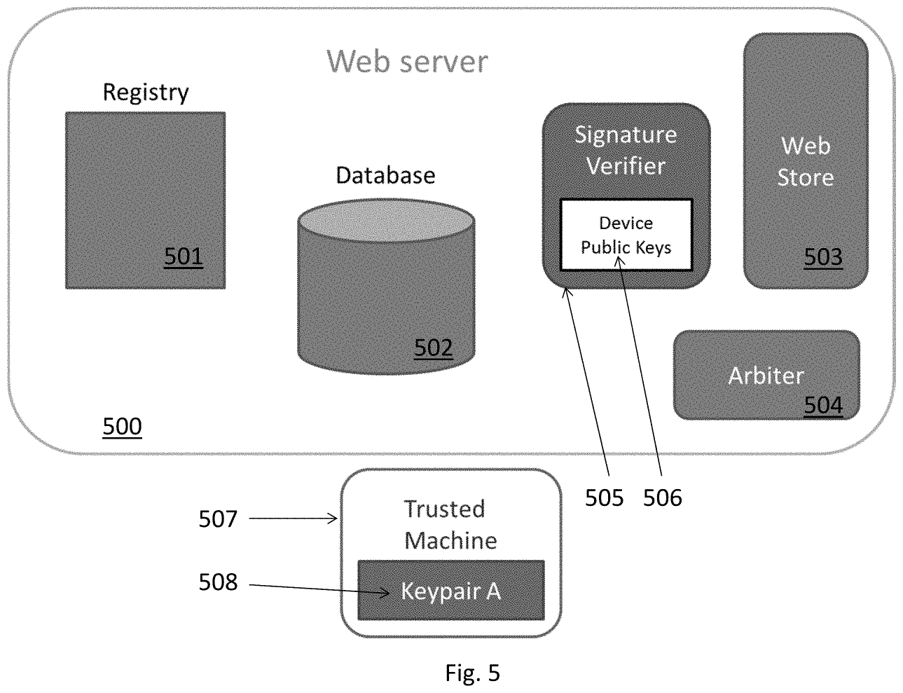

An overview of the server system is shown in FIG. 5, where the webserver 500 comprises a registry 501, database 502, web store 503, arbiter 504, and signature verifier 505 with device public keys 506. A trusted machine 507 providing a first key pair 508 is external to the server system 500. The registry 501 holds developer registration information, including public keys 506. The database 502 contains encrypted copies of developer software/models, using the Trusted Machine 507 to encrypt. The Signature Verifier 505 is used to verify that devices requesting code are truly safe devices provided from a third party. The Trusted Machine 507 is an extremely secure, external machine with a first key pair “A” 508 used to encrypt and decrypt entries into the database 502 safely. The Web Store 503 is the web frontend where users may browse and download new models/software. The Arbiter 504 is the software which handles software requests, encryption and signature commands, and database functions.

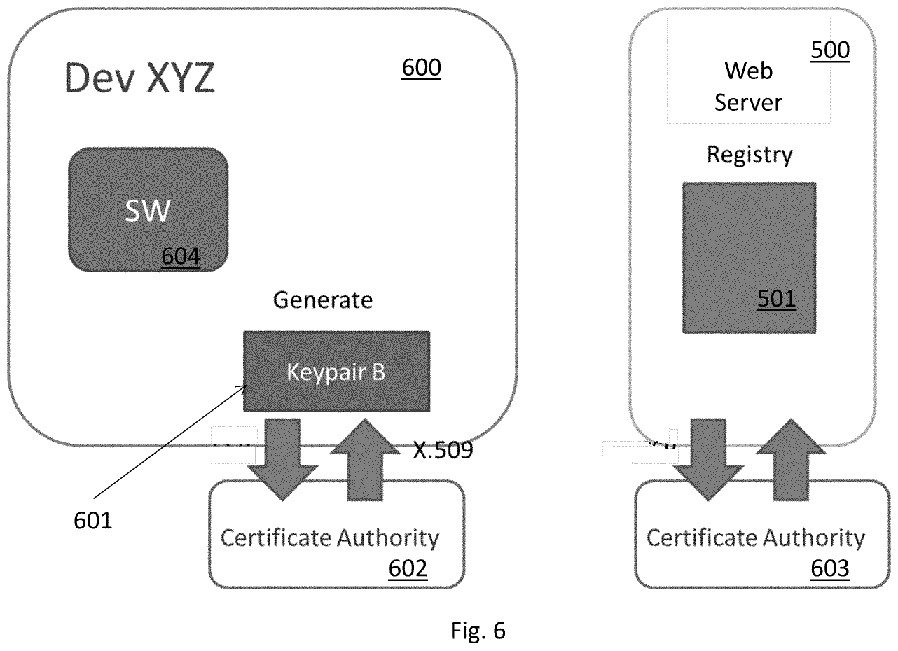

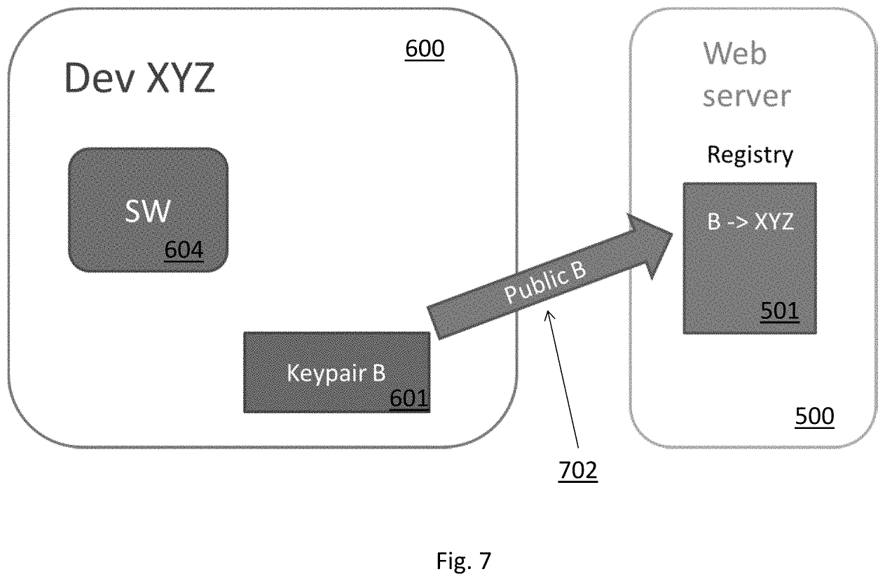

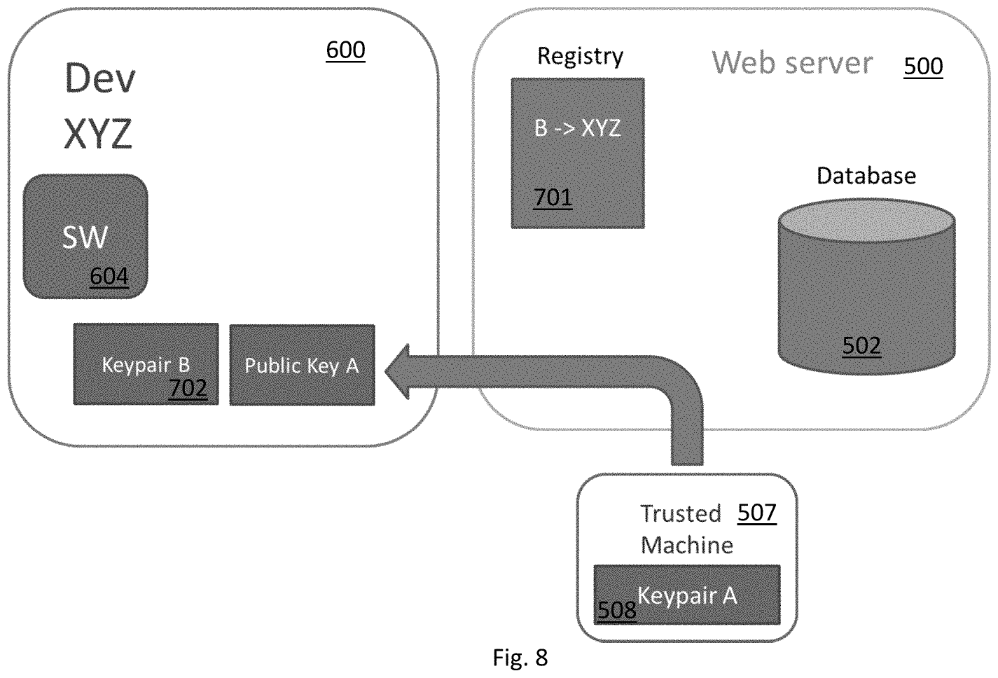

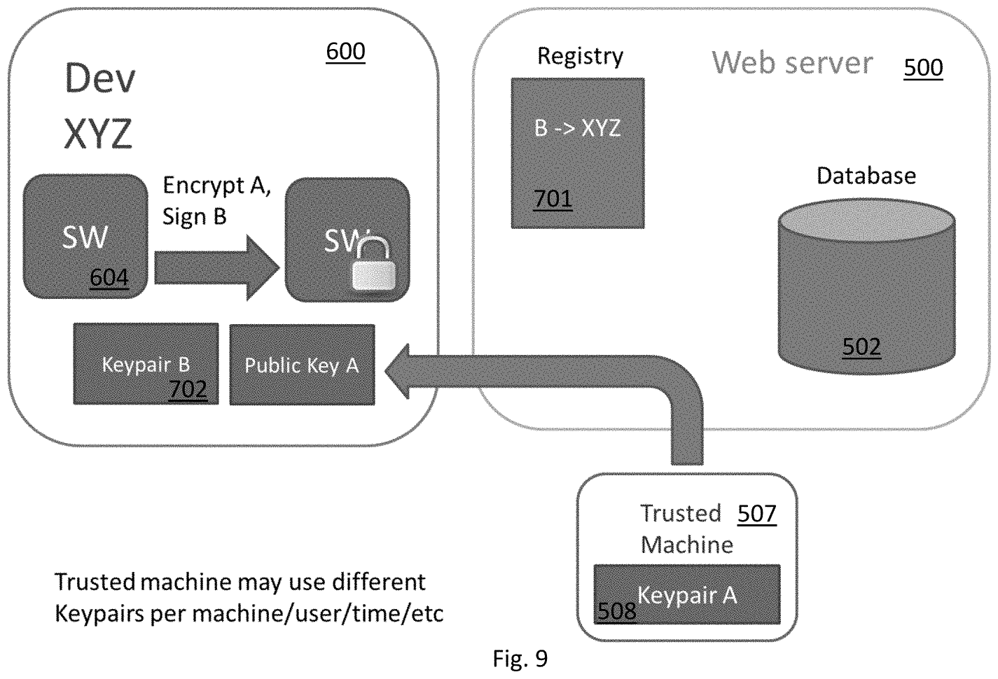

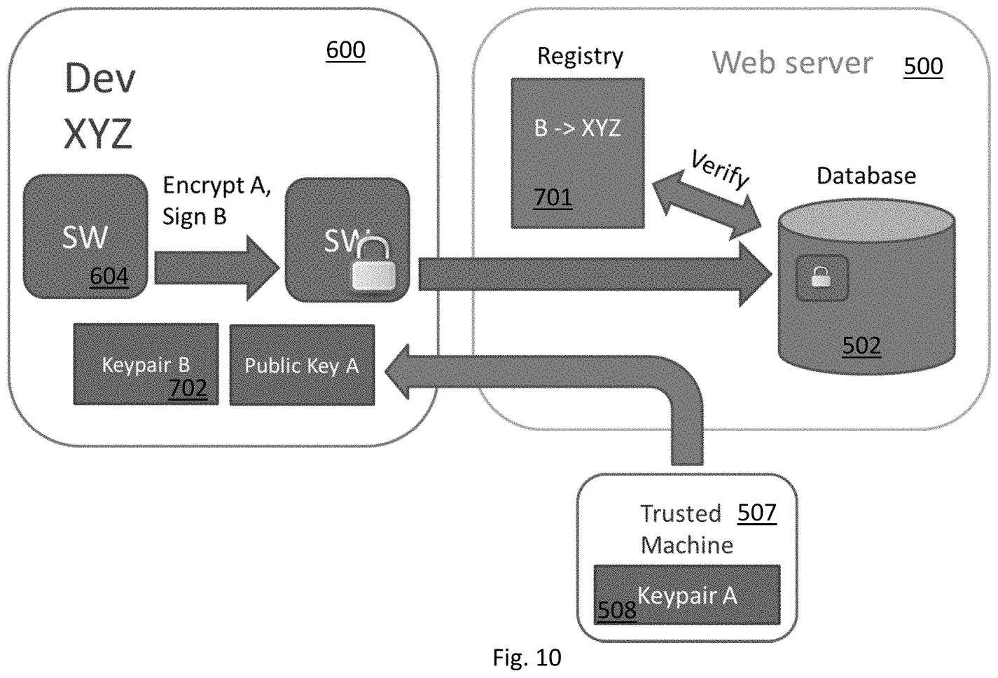

In a first illustrative Example 1, shown in FIGS. 6-10, the Developer XYZ 600 wants to develop hardware/software for the web store. Developer XYZ 600 first registers with the website so that their code can be identified. First, they generate a key pair 601 which Developer XYZ 600 will keep and protect (private part). Authentication of a developer PC and the server using SSL certificates 602 occurs. Next, Developer XYZ 600 submits the Public Key B 702 from Key Pair B 601 to the registry 500 as identifying their products. The web server 500 stores this key in the registry 501. Now, the web server 500 can verify that any products uploaded to the database are truly from who they say they're from. Developer XYZ 600 is then given the public key from Key pair a 508, to encrypt their product SW 604 before sending it. They encrypt their product with the public key A 508, and then sign it with their private key B 601, creating a signed and encrypted package. Finally, Developer XYZ 600 sends this protected package 603 to the web server. The database verifies the source before storing the product SW 604.

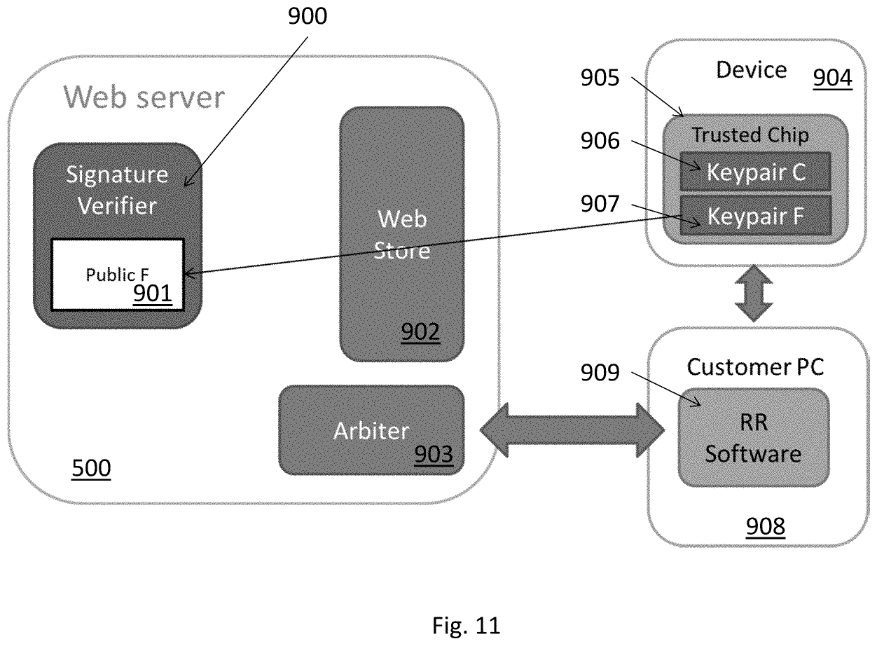

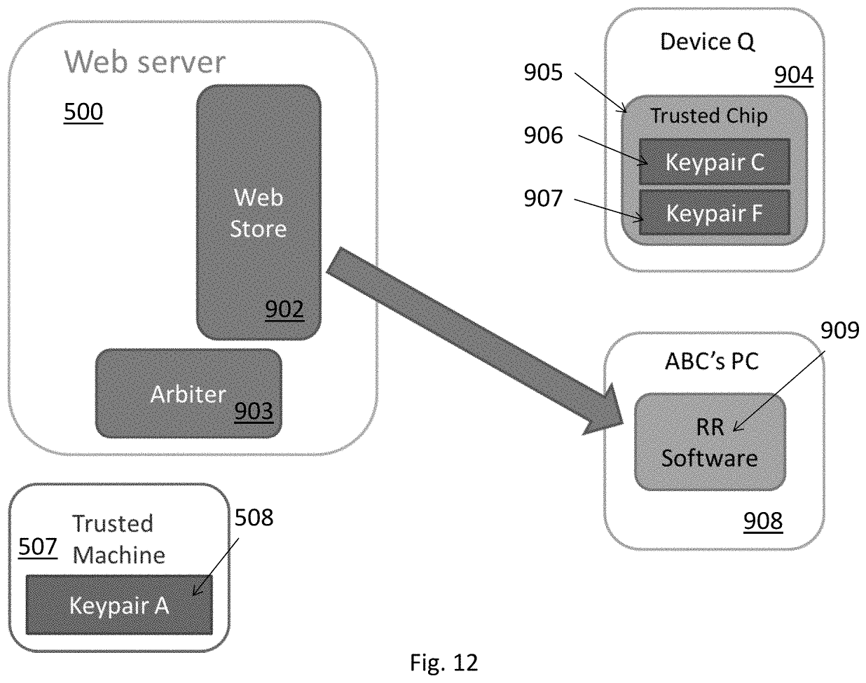

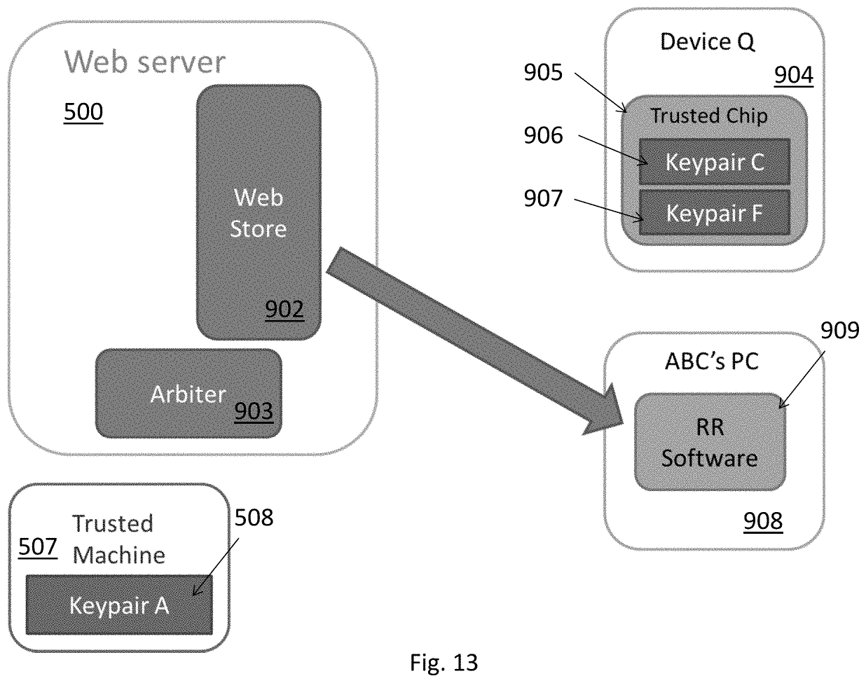

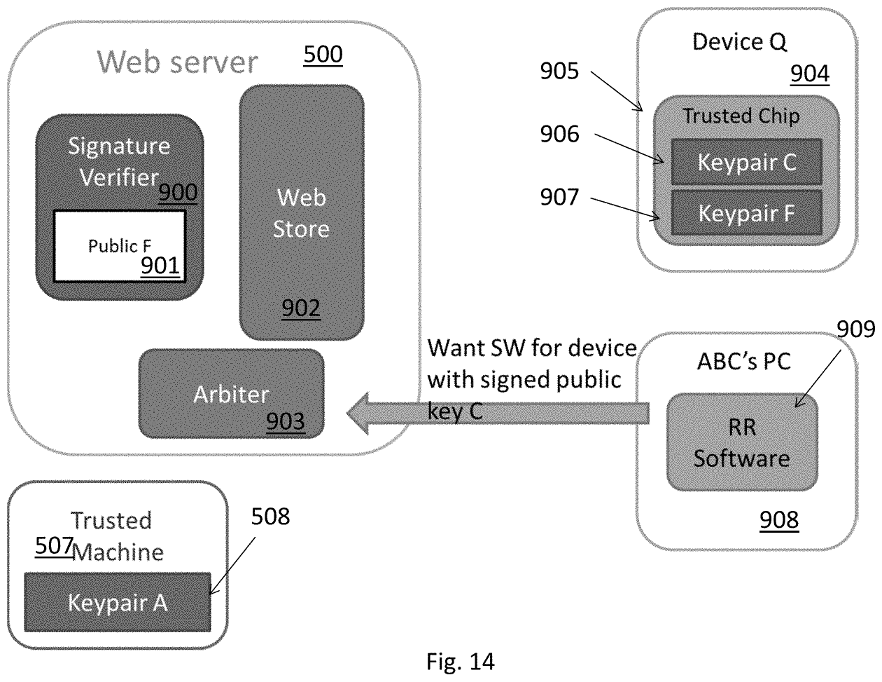

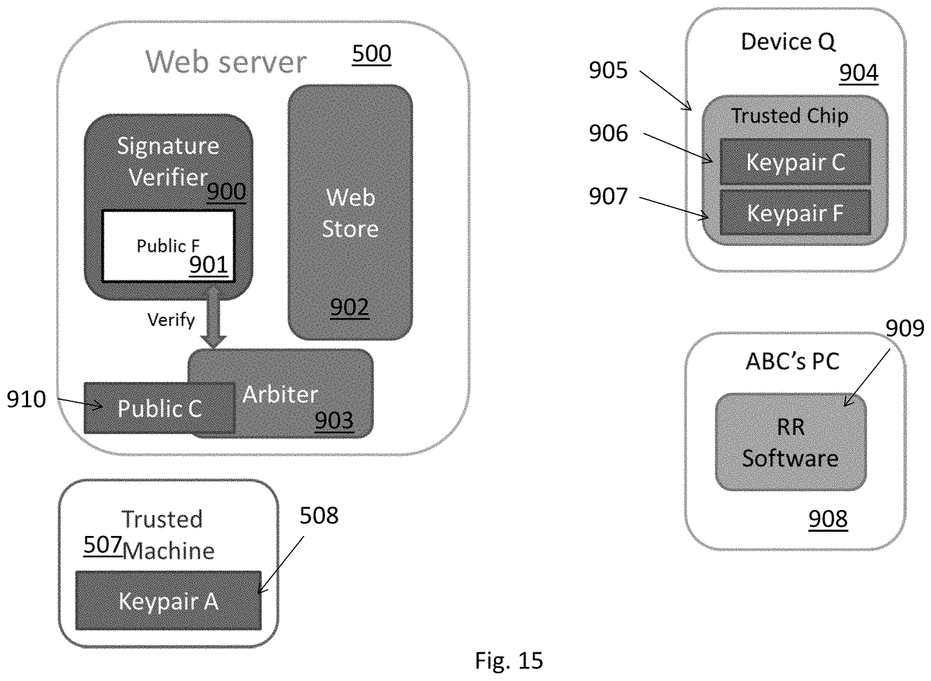

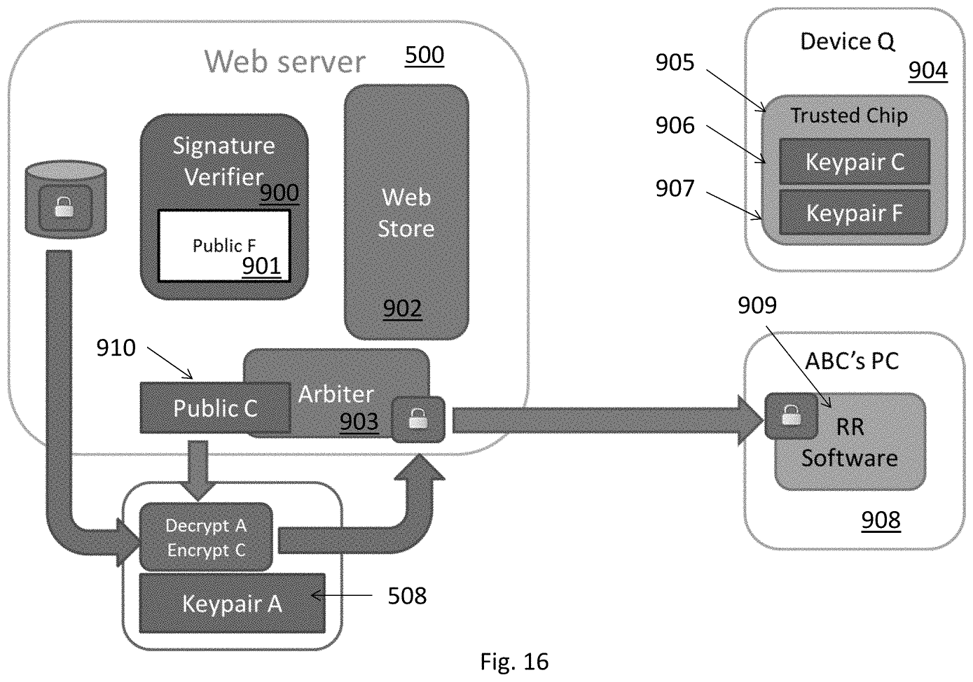

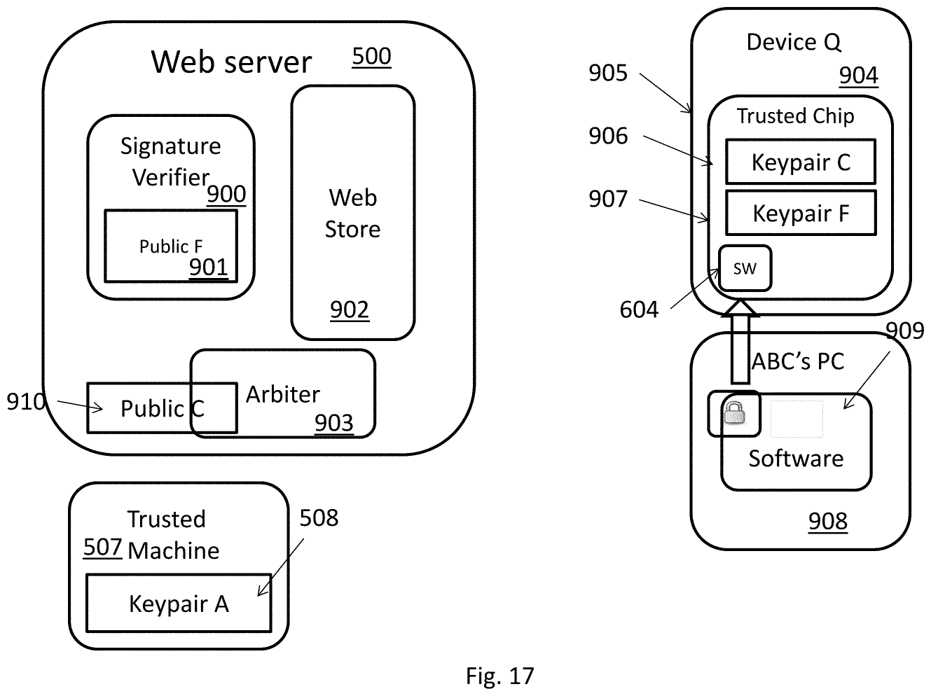

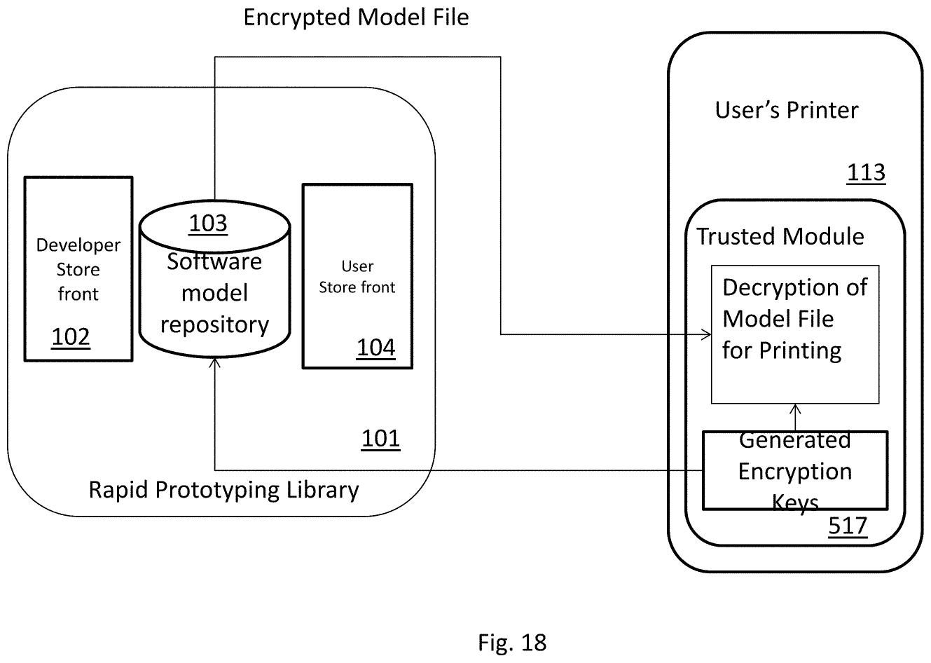

In a second illustrative example shown in FIGS. 11-17, the device side is explained. The device 904 contains a trusted chip 905 with two keys: Key pair F 907 used to verify the device, and Key pair C 906 to encrypt software for the device. The Public key F 901 is stored on the Signature Verifier 900 when the device is purchased. The web server 500 software runs on the PC which allows browsing of the web store 902 and downloading of encrypted software packages, using the Arbiter 903. Next, the Customer ABC browses the store and decides to purchase SW from XYZ (authentication of ABC is skipped). First, requests are assigned a serial number from the device to send to web server 500. Next the customer's PC 908 requests software SW from the Arbiter 903, sending 909 the signed serial number with the request to the customer's PC 908. Next, the Arbiter 903 requests verification of the signature from the customer's PC 908. If it matches, the Arbiter 903 will send on the device-specific encrypted package to the customer's PC 908. Upon verification, Trusted Machine 507 decrypts SW with Private Key a 508, then re-encrypts with Public Key C 906. The package is sent to ABC. ABC uploads the software to the device, which decrypts are with Private Key C 906 in order to run.

The present invention also allows for keying the parts to the printer or to the micro-controls that work with the part. The 3D printer can add a code inside of the 3D printed material or part that identifies where the part has been printed. This can be accomplished by leaving gaps, or partially printed sections, in the physical part where the part can be easily cut apart revealing the code to determine where it was made. In the alternative, the 3D printer can embed holes into the part for later forensic use to obtain information about that part, in a Morse code or Braille fashion, where those holes would correspond to the raised dots of Braille or replicate a series of long and short signals (where the “signal” is in the form of long and short holes) which correspond to Morse code. The printed part would simply be an inverse of Morse code, where the bumps and holes have the same representation. The information can include the model, where printed, who purchased the printer, material, and printer serial number. The information can also include details so that the part can be traced back to the printing source.

All submissions from developers are verified before being added to the database 502. Products are only ever decrypted inside of the trusted machine 507 and on the actual device using the package. Packages are not sent to users without first verifying the end device. Each package distributed to a user is only usable on the specified device. Devices have two key pairs due to current commercial off-the-shelf (COTS) technology implementations.

In another embodiment of the present invention, printer authentication can be combined with the security system to enable a single time printing protocol. A trusted module 517 would be associated with the printer which comprises a random sequence generator. The printer 113 will generate the next keys required for printing and authorization using a Common Access Card (CAC). Next the server would encrypt the model with the keys generated by the trusted module of the printer 113 to allow for the printer to decrypt the keys and effectuate printing of the encrypted model. This would limit printing of the model file sent from the Rapid Prototyping Library 100 to the printer 113 to only that specific printer 113. If the model file was copied or hijacked during transmission, it would be unable to be executed or printed by any other 3D printer as there would be no printer authentication to unlock the file for use as any other printer, even with a trusted module 517 would be unable to decrypt the file due to the missing encryption keys.

The system is set to run on a computing device. A computing device on which the present invention can run would comprises a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for communicating hardware designs and associated software, comprising the steps of:
providing a computer executing software for controlling one or more 3D printers;
providing a 3D printer;
authentication of one or more users by the computer;
authentication of a store;
offering a plurality of 3D models for printing in the store;
authentication of the ownership of the 3D models offered for printing through the store;
authentication of the one or more 3D printer devices; and
encrypting hardware models for transfer from the user to the store and transfer from the store to the one or more 3D printer devices for authentication by a recipient store or printer devices.

2. The method of claim 1, further comprising the step of
providing one or more trusted modules at the 3D printer devices, where one of the trusted modules located at the 3D printer is used to supply keys for the encryption.

3. The method of claim 1, further comprising the step of
providing trusted modules at all of the 3D printer devices to supply keys for an encryption and an authentication of hardware models; and
generating security keys by the trusted modules for the encryption and authentication of printable 3D parts on the 3D printers.

4. The method of claim 1, further comprising the step of
using cryptography to generate a unique authentication and security key for each of the models to one or more 3D printer devices deployed for remote printing.

5. The method of claim 1, further comprising the step of
using cryptography to protect the models so they can only be printed by authenticated 3D printers.

6. The method of claim 1, further comprising the step of
providing a webserver comprising a registry, database, web store, arbiter, and signature verifier with device public keys.

7. The method of claim 6, wherein
an external trusted machine, with respect to the webserver, provides a first key pair to the webserver;
the database contains encrypted copies of developer software/models, using the Trusted Machine to encrypt;
the Signature Verifier verifies that external trusted machine requesting a code is a device provided from a third party known to be or identified as safe;
the Trusted Machine provides a first key pair “A” used to encrypt and decrypt entries into the database in a trusted manner;
a trusted module is associated with the any of the 3D printers;
the trusted module provides a random sequence generator at the 3D printer;
a 3D printer generates keys required for printing and authorization using a Common Access Card (CAC); and
the webserver encrypts a requested model with the keys generated by the trusted module of any 3D printer to allow for the selected 3D printer to decrypt the keys and effectuate printing of the encrypted requested model.

8. The method of claim 1, further comprising the step of
creating identification on the parts printed corresponding to a printer which printed them.

9. The method of claim 1, further comprising the step of
creating identification on the parts printed corresponding to one or more micro-controls that work with a printed part.

10. The method of claim 1, further comprising the step of
adding a code inside of a 3D printed part that identifies where the 3D printed part has been printed; and
leaving gaps in the 3D printed part so that the 3D printed part can be cut apart and opened to expose the code for identifying where the 3D part was printed.

11. The method of claim 1, further comprising the step of
embedding holes into a printed part for later forensic use to obtain information about the part.

12. The method of claim 11, wherein the information includes a model number, a printing location, identification on who purchased a printer and printing material, and a printer serial number.

13. The method of claim 11, wherein the information can be traced back to a printing source.

14. A Method to Protect Deployable Rapid On-Site Manufacturing 3D Printing Systems, comprising:
providing a webserver comprising a registry, database, web store, arbiter, and signature verifier with device public keys;
providing a trusted machine generating a first key pair external to the webserver;
using the registry to hold developer registration information, including one or more public keys;
using the database to store encrypted copies of developer software models, using the Trusted Machine to encrypt;
using the Signature Verifier to verify that external third party devices requesting a key code are verified external devices provided from a third party;
generating a first key pair “A” by the trusted machine used to encrypt and decrypt entries into the database;
handling software requests, encryption and signature commands, and database functions by the Arbiter;
providing a trusted module associated with a 3D printer which comprises a random sequence generator for generating keys at the 3D printer;
generating the keys required for printing by the 3D printer and authorization using a Common Access Card; and
encrypting a model by the server with the keys generated by the trusted module of the printer to allow for the 3D printer to decrypt the keys and effectuate printing of the encrypted model.

15. The method of claim 14, further comprising the step of providing a Web Store that is a web frontend where users may browse and download new models/software.

16. The method of claim 14, further comprising the step of limiting printing of a model file sent from a Rapid Prototyping Library to a specific 3D printer.
